(19) United States
(12) Patent Application Publication
(10) Pub. No.: US 2023/0394539 A1
(43) Pub. Date: Dec. 7, 2023

(54) Graphical User Interface for Matching Documents

(71) Applicant: Bottomline Technologies, Inc., Portsmouth, NH (US)

(72) Inventors: Sandhya Pillalamarri, Acton, MA (US); Leonardo Gil, Manchester, NH (US); Amanda Boston, North Berwick, ME (US); Caitlin Reardon, Dover, NH (US)

(73) Assignee: Bottomline Technologies, Inc., Portsmouth, NH (US)

(21) Appl. No.: 17/874,999

(22) Filed: Jul. 27, 2022

Related U.S. Application Data
(63) Continuation-in-part of application No. 29/841,560, filed on Jun. 7, 2022.

(51) Int. Cl. G06Q 30/04; G06Q 20/14

(52) U.S. Cl. CPC G06Q 30/04; G06Q 20/14

(57) ABSTRACT

Disclosed is an apparatus for matching a payment received from a remitter for two or more invoices generated by a beneficiary against invoices of two or more customers associated with the remitter. The apparatus includes a storage unit for storing a plurality of computer program instructions, a graphical user interface for displaying a graphical output, and a processing unit for processing the plurality of computer program instructions. The plurality of computer program instructions includes a payment receive module to receive a payment from the remitter, a total amount module to display the total amount received from the remitter, a customer account module to display a list of invoices generated by the beneficiary against the customers associated with the remitter, and a split payment module to split the total amount into multiple split amounts. Each split amount matches the amount on at least one customer's invoice, and the total amount matches the sum of amounts on two or more customer's invoices.

### CROSS-REFERENCE TO RELATED APPLICATION

The present application is a continuation-in-part application of a design patent application No. 29841560, filed Jun. 7, 2022, entitled “Display Screen with an Animated Graphical User Interface,” the entire disclosures of which are incorporated herein by reference.

### BACKGROUND OF THE INVENTIONS

### 1. Field of the Inventions

The present application generally relates to a graphical user interfaces and more specifically relates to for the graphical user interfaces for matching documents.

### 2. Description of Related Art

An accounts payable function includes the tasks of processing invoices, matching invoices with purchase orders and receipts, approving invoices for payment, managing terms, paying invoices based on the terms, applying credits, and confirming payment of invoices.

Accounts receivable duties include ensuring accuracy and efficiency of operations, processing and monitoring incoming payments, and securing revenue by verifying and posting receipts. In a bill delivery and payment system, the accounts receivable team is able to access a server computer on a communications network to obtain details of the received payments, obtain a list of pending invoices, and then match the invoices with the payments.

Therefore, there is a need for an apparatus for matching a payment received from a remitter for two or more invoices generated by a beneficiary against invoices of two or more customers associated with the remitter. The apparatus should also be able to automatically match the invoice with the split amount of the received payment.

### SUMMARY OF THE INVENTIONS

In accordance with the teachings of the present inventions, the apparatus for matching a payment received from a remitter for two or more invoices generated by a beneficiary against invoices of two or more customers associated with the remitter is provided.

An object of the present inventions is to provide an apparatus having a storage unit for storing a plurality of computer program instructions, a graphical user interface for displaying graphical output of the plurality of processed computer program instructions, and a processing unit coupled to the storage unit and the graphical user interface for processing the plurality of computer program instructions.

The plurality of computer program instructions includes a payment receive module to receive a payment associated with two or more customers from the remitter, a total amount module coupled to the payment receive module to display the total amount received from the remitter, a customer account module coupled to the payment receive module to display a list of invoices generated by the beneficiary against the customers associated with the remitter, and a split payment module coupled to the total amount module to split the total amount into multiple split amounts, wherein each split amount matches to the amount on at least one customer's invoice, wherein the total amount matches to the sum of amounts on two or more customer's invoice.

Another object of the present inventions is to provide an apparatus with a notification module to notify the remitter about the receipt of payments for the invoices, an allocation module to display an amount allocated from the payments received from the remitter, and an invoice addition module to allow the addition of customer invoices that match with the split amount.

Another object of the present inventions is to provide an apparatus wherein the split payment module is programmed with a machine-learning artificial intelligence neural network to automatically split the received payment from the remitter into two or more amounts, wherein each amount matches with the amount on the customer invoice.

While a number of features are described herein with respect to embodiments of the inventions; features described with respect to a given embodiment also may be employed in connection with other embodiments. The following description and the annexed drawings set forth certain illustrative embodiments of the inventions. These embodiments are indicative, however, of but a few of the various ways in which the principles of the inventions may be employed. Other objects, advantages, and novel features according to aspects of the inventions will become apparent from the following detailed description when considered in conjunction with the drawings.

### BRIEF DESCRIPTION OF DRAWINGS

The annexed drawings, which are not necessarily to scale, show various aspects of the inventions in which similar reference numerals are used to indicate the same or similar parts in the various views.

FIG. 1 is a block diagram to illustrate a relationship matrix between a remitter, a beneficiary, and an apparatus;

FIG. 2 is a block diagram to illustrate the apparatus;

FIG. 3 is a screenshot showing a plurality of modules in an exemplary embodiment of the present inventions; and

FIG. 4 is another screenshot showing the plurality of modules in another exemplary embodiment of the present inventions.

### DETAILED DESCRIPTION OF DRAWINGS

The present disclosure is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

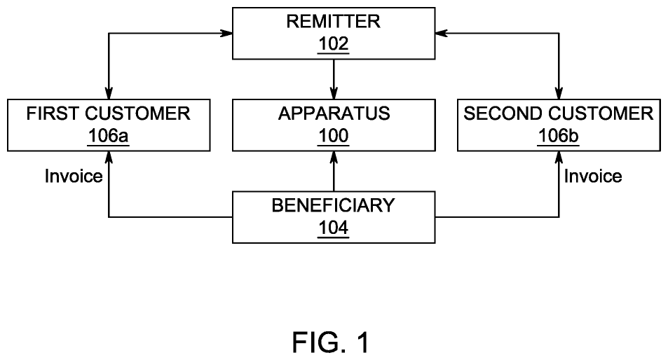

FIG. 1 is a block diagram to illustrate a relationship matrix between an apparatus 100, a remitter 102, a beneficiary 104, and a plurality of customers 106a, 106b. The beneficiary 104 raises invoices against a first customer 106a and a second customer 106b. The remitter 102 is associated with the first customer 106a and the second customer 106b.

In an exemplary embodiment of the present inventions, the remitter 102 is a parent organization of the first customer 106a and the second customer 106b. Alternatively, remitter 102 is a third-party organization that manages the invoices for the first customer 106a and the second customer 106b.

The remitter 102 pays on behalf of the invoices raised to the customers 106a, 106b by the beneficiary 104. The Beneficiary 104 then utilizes the apparatus 100 to track the invoices, match them with the payment, and notify the customers 106a, 106b and the remitter 102 about receipt of the payments.

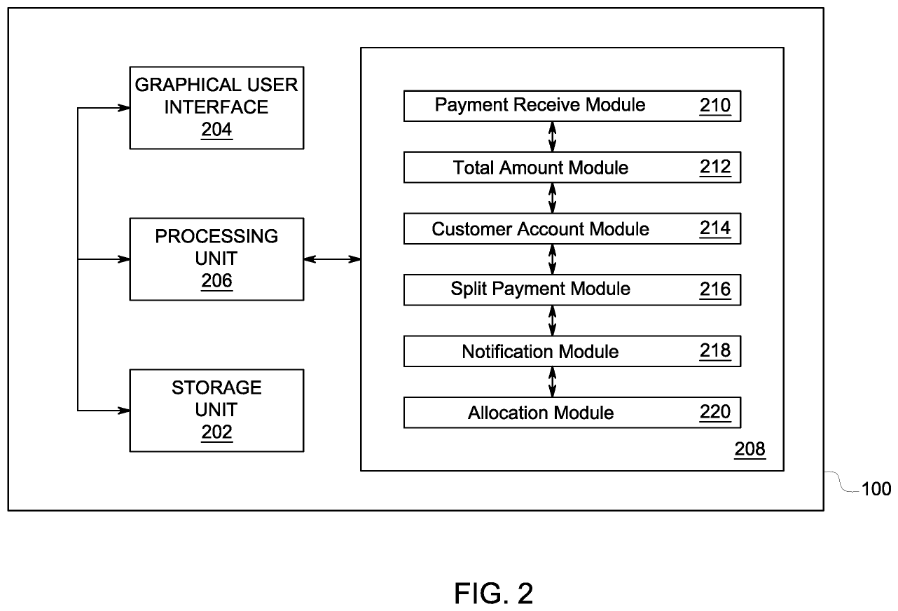

FIG. 2 is a block diagram to illustrate the apparatus 100. The apparatus 100 matches a payment received from the remitter (102, shown in FIG. 1) for two or more invoices generated by the beneficiary (104, shown in FIG. 1) against invoices of two or more customers (106a, 106b) associated with the remitter (102, shown in FIG. 1).

The apparatus 100 includes a storage unit 202, a graphical user interface 204, and a processing unit 206. The storage unit 202 stores a plurality of computer program instructions 208. The graphical user interface 204 displays a graphical output of the plurality of processed computer program instructions.

The processing unit 206 is coupled to the storage unit 202 and the graphical user interface 204 for processing the plurality of computer program instructions 208. The plurality of computer program instructions 208 includes a payment receive module 210, a total amount module 212, a customer account module 214, and a split payment module 216.

The payment receive module 210 receives a payment associated with two or more customers from the remitter. The total amount module 212 is coupled to the payment receive module to display the total amount received from the remitter. The customer account module 214 is coupled to the payment receive module 210 to display a list of invoices generated by the beneficiary against the customers associated with the remitter.

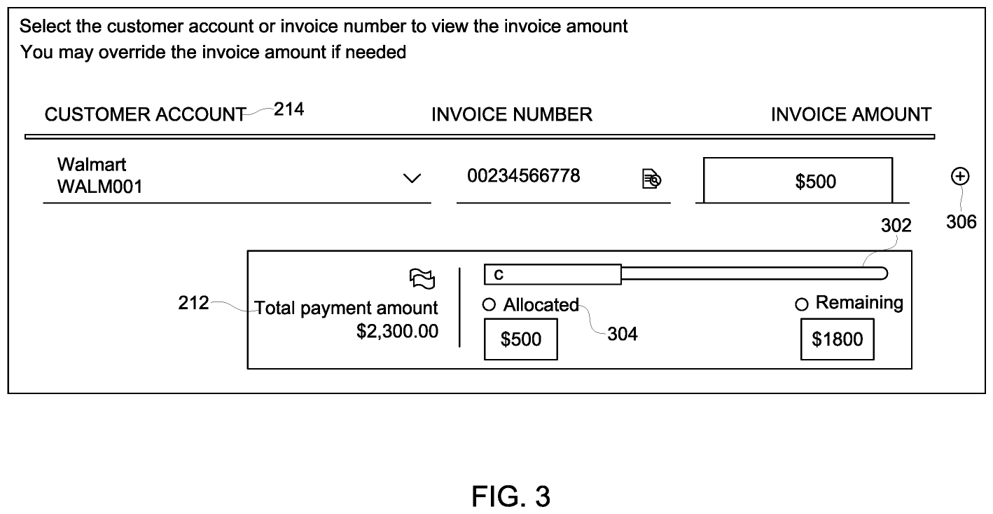

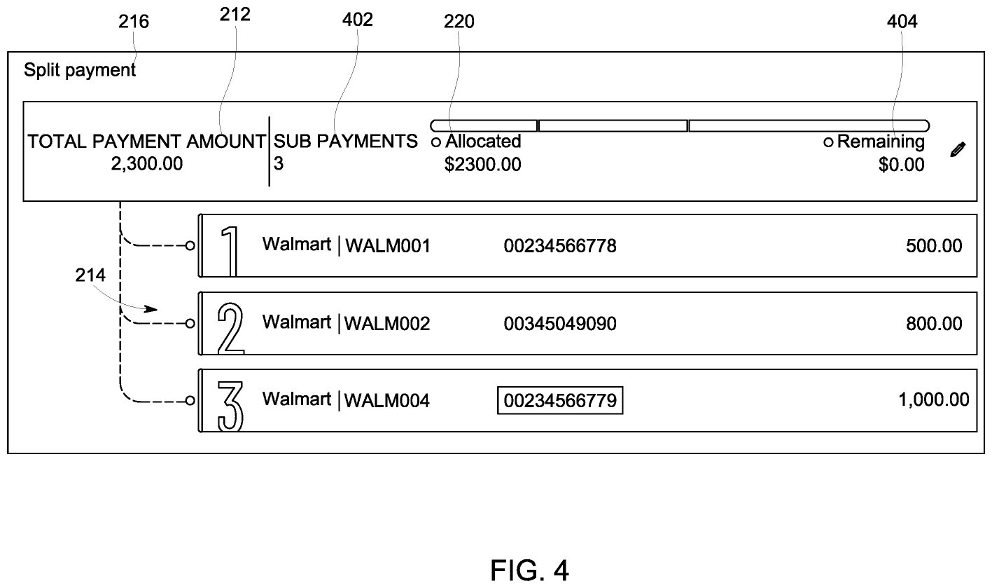

The split payment module 216 is coupled to the total amount module 212 to split the total amount into multiple split amounts. Each split amount matches the amount on at least one customer's invoice. The total amount matches the sum of amounts on two or more customers' invoices. The total amount module 212, the customer account module 214, and the split payment module 216 are explained in detail in conjunction with FIG. 3 to FIG. 4 of the present inventions.

In another embodiment of the present inventions, the plurality of modules further includes a notification module 218 to notify the remitter about receiving payments for the invoices. The notification may be communicated via email, SMS, or any other digital communication without deviating from the scope of the present invention.

Examples of the storage unit 202 includes but not limited to a permanent mass storage device, such as random access memory (RAM), read only memory (ROM), a disk drive, a solid state drive, flash memory, etc., as a non-transitory computer-readable storage medium.

The graphical user interface (GUI) 204 discussed herein may be provided in the form of text-based user interface systems, virtual, augmented, or mixed reality (VAMR) interface systems, projection based systems, gesture controlled systems, and/or any other type of visual user interfaces. Although some of the principles discussed herein are discussed specifically with respect to, for example, a GUI, however, no limitation is intended, and the principles discussed herein may equally be applied to other interface systems.

GUI described herein refer to “displays,” “interfaces,” and “user interfaces.” As used herein, unless stated otherwise, the terms “display,” “interface,” and “user interface,” refer to the text, images, visual components, interactive elements, and any other visual aspects that are shown or displayed on a screen, projection, or other visual display hardware. It is thus understood that “displays” and “interfaces,” as used herein, may be provided via any type of visual display hardware, screen(s) and/or projector, without deviating from the scope of the present invention.

The processing unit 206 of the apparatus 100 may have various implementations without deviating from the scope of the present inventions. For example, each of the processing unit 206 may include any suitable device, such as a programmable circuit, integrated circuit, memory and I/O circuits, an application-specific integrated circuit, microcontroller, complex programmable logic device, other programmable circuits, or the like. Each of the processing unit 206 may also include a non-transitory computer-readable medium, such as random access memory (RAM), a read-only memory (ROM), an erasable programmable read-only memory (EPROM or Flash memory), or any other suitable medium. Instructions for performing the methods described above may be stored in the non-transitory computer-readable medium and executed by the respective processing unit 206 identified in the description of the method.

FIG. 3 is a screenshot showing the plurality of modules in an exemplary embodiment of the present inventions. The customer account module 214 displays the list of invoices of the customer to a user operating the apparatus. The user may enter login credentials to enter into the customer account. Further, the user selects a customer to check the list of invoices associated with the customer. Generally, a customer account includes details such as customer ID, invoice number, and invoice amount.

As shown in FIG. 3, the total amount module 212 displays the received total amount. For exemplary purposes, the total amount module 212 displays $2300 as the total amount. The user selects a customer using a drop-down menu to split the payments accordingly. The customer is Walmart and an associated customer ID is WALM001 (possibly representing an individual Walmart store), the invoice number is 00234566778 and the invoice amount is $500.

In another embodiment of the present inventions, the plurality of instructions further includes an allocation module (220, shown in FIG. 2) that displays a bar line 302 to show an amount allocated 304 from the payments received from the remitter, and an invoice addition module 306 to allow the addition of customer invoices that match with the split amount. For exemplary purposes, the amount allocated is $500 against the invoice WALM001, and the remaining amount is $1800.

FIG. 4 is another screenshot showing the plurality of modules in another exemplary embodiment of the present inventions. The customer account module 214 further allows the user to select two or more invoices raised against the customer whose amount matches the total amount received from the remitter.

In an exemplary embodiment, the total amount module 212 displays the receipt of the total payment of $2300. The split payment module 216 allows the user to split the total received payment into three sub-payments 402. The three sub-payments 402 are divided into three customer invoices with amounts of $500, $800, and $1000, respectively. The total amount module 212 displays total allocated amount 302 is $2300 ($500+$800+$1000), and the total remaining amount 404 is $0.

The customer account module 214 includes three customer invoices WALM001 bearing invoice number 00234566778, WALM002 bearing invoice number 00345049090 & WALM003 bearing invoice number 00234566779. It would be readily apparent to those skilled in the art that the total amount module 212 allows splitting of the total amount into multiple sub-payments 402 without deviating from the scope of the present inventions.

In another embodiment, the split payment module 214 is programmed with a machine-learning artificial intelligence neural network to automatically split the received payment into multiple amounts, wherein each amount matches with the amount on the customer invoice. It would be readily apparent to those skilled in the art that various ways of machine learning may be envisioned without deviating from the scope of the present inventions.

In another embodiment, a method for matching a payment received from a remitter for two or more invoices generated by a beneficiary against invoices of two or more customers associated with the remitter is provided. The method initiates with a step of storing a plurality of computer program instructions via a storage unit, followed by a step of displaying a graphical output of the plurality of computer program instructions via a graphical user interface; and concluding at a step of processing the plurality of computer program instructions via a processing unit coupled to the storage unit and the graphical user interface. The plurality of computer program instructions are explained in detail in conjunction with FIG. 2 to FIG. 4 of the present inventions.

The present inventions offer various advantages such as splitting the amount and matching it with each invoice of the customer, which allows the beneficiary to keep track of each invoice. The present inventions further offer a machine-learning module to automatically split the received payment into two or more amounts and match with the amount on customer invoices to maintain the payments of a remitter.

The machine-learning module stores each payment received from the customers or remitters. Further, the machine-learning module stores each split payment manually done by the user and then utilizes machine-learning to know and automatically process the splitting of the total amount received from the customer into multiple split amounts that matches the amount on the invoice received from the customer.

Thus, the apparatus automatically maintains the record of each invoice and matches it with the correct received payment. The matching of the payments with customers and invoices is further described in U.S. Ser. No. 17/489,058 titled “Automatic Matching of Datasets”, invented by Amanda Boston and filed on Sep. 29, 2021 is incorporated herein by reference in its entirety.

It should be appreciated that many of the elements discussed in this specification may be implemented in a hardware circuit(s), a circuitry executing software code or instructions that are encoded within computer-readable media accessible to the circuitry, or a combination of a hardware circuit(s) and a circuitry or control block of an integrated circuit executing machine-readable code encoded within a computer-readable media. As such, the term circuit, module, server, application, or other equivalent description of an element as used throughout this specification is, unless otherwise indicated, intended to encompass a hardware circuit (whether discrete elements or an integrated circuit block), a circuitry or control block executing code encoded in a computer-readable media, or a combination of a hardware circuit(s) and a circuitry and/or control block executing such code.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the inventions have been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the inventions. In addition, while a particular feature of the inventions may have been described above with respect to only one or more of several illustrated embodiments, such feature may be combined with one or more other features of the other embodiments, as may be desired and advantageous for any given or particular application.

1. An apparatus for matching a payment received from a remitter for two or more invoices generated by a beneficiary against invoices of two or more customers associated with the remitter, the apparatus comprising:
a storage unit for storing a plurality of computer program instructions;
a graphical user interface for displaying a graphical output of the plurality of computer program instructions; and
a processing unit coupled to the storage unit and the graphical user interface for processing the plurality of computer program instructions, wherein the plurality of computer program instructions comprising:
a payment receive module to receive the payment associated with the two or more customers from the remitter;
a total amount module coupled to the payment receive module to display a total amount received from the remitter;
a customer account module coupled to the payment receive module to display a list of invoices generated by the beneficiary against the customers associated with the remitter; and
a split payment module coupled to the total amount module to split the total amount into multiple split amounts, wherein each split amount matches to the amount on at least one customer's invoice, wherein the total amount matches to a sum of amounts on two or more customer's invoice.

2. The apparatus according to claim 1 wherein the plurality of modules further comprising a notification module to notify the remitter about receipt of payments for the invoices.

3. The apparatus according to claim 1 wherein the plurality of modules further comprising an allocation module to display an amount allocated from the payments received from the remitter.

4. The apparatus according to claim 1 wherein the plurality of modules comprising an invoice addition module to allow addition of customer invoices that match the split amount.

5. The apparatus according to claim 1 wherein the split payment module is programmed with a machine-learning artificial intelligence neural network to automatically split the received payment from the remitter into two or more amounts, wherein each amount matches with the amount on the customer invoice.

6. A method for matching a payment received from a remitter for two or more invoices generated by a beneficiary against invoices of two or more customers associated with the remitter, the method comprising:
storing a plurality of computer program instructions via a storage unit;
displaying a graphical output of the plurality of computer program instructions via a graphical user interface; and
processing the plurality of computer program instructions via a processing unit coupled to the storage unit and the graphical user interface, wherein the plurality of computer program instructions comprising:
a payment receive module to receive the payment associated with the two or more customers from the remitter;
a total amount module coupled to the payment receive module to display a total amount received from the remitter;
a customer account module coupled to the payment receive module to display a list of invoices generated by the beneficiary against the customers associated with the remitter; and
a split payment module coupled to the total amount module to split the total amount into multiple split amounts, wherein each split amount matches to the amount on at least one customer's invoice, wherein the total amount matches to a sum of amounts on two or more customer's invoice.

7. The method according to claim 6 wherein the plurality of modules further comprising a notification module to notify the remitter about receipt of payments for the invoices.

8. The method according to claim 6 wherein the plurality of modules further comprising an allocation module to display an amount allocated from the payments received from the remitter.

9. The method according to claim 6 wherein the plurality of modules comprising an invoice addition module to allow addition of customer invoices that match the split amount.

10. The method according to claim 6 wherein the split payment module is programmed with a machine-learning artificial intelligence neural network to automatically split the received payment from the remitter into two or more amounts, wherein each amount matches with the amount on the customer invoice.

11. A non-transitory computer-readable storage medium having stored thereon a plurality of computer program instructions which are programmed to match a payment received from a remitter for two or more invoices generated by a beneficiary against invoices of two or more customers associated with the remitter, wherein the plurality of computer program instructions are further programmed to:
store the plurality of computer program instructions via a storage unit;
display a graphical output of the plurality of computer program instructions via a graphical user interface; and
process the plurality of computer program instructions via a processing unit coupled to the storage unit and the graphical user interface, wherein the plurality of computer program instructions comprising:
a payment receive module to receive the payment associated with the two or more customers from the remitter;
a total amount module coupled to the payment receive module to display a total amount received from the remitter;
a customer account module coupled to the payment receive module to display a list of invoices generated by the beneficiary against the customers associated with the remitter; and
a split payment module coupled to the total amount module to split the total amount into multiple split amounts, wherein each split amount matches to the amount on at least one customer's invoice, wherein the total amount matches to a sum of amounts on two or more customer's invoice.

12. The method according to claim 11 wherein the plurality of modules further comprising a notification module to notify the remitter about receipt of payments for the invoices.

13. The method according to claim 11 wherein the plurality of modules further comprising an allocation module to display an amount allocated from the payments received from the remitter.

14. The method according to claim 11 wherein the plurality of modules comprising an invoice addition module to allow addition of customer invoices that match the split amount.

15. The method according to claim 11 wherein the split payment module is programmed with a machine-learning artificial intelligence neural network to automatically split the received payment from the remitter into two or more amounts, wherein each amount matches with the amount on the customer invoice.
